(19) United States
(12) Patent Application Publication
(10) Pub. No.: US 2008/0088732 A1
(43) Pub. Date: Apr. 17, 2008

(54) Lens structure

(75) Inventor: Tzu-Chih Lin, Jhudong Township (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Altek Corporation, Hsinchu (TW)

(21) Appl. No.: 11/699,844

(22) Filed: Jan. 30, 2007

(30) Foreign Application Priority Data
Oct. 13, 2006 (TW) 095137780

(51) Int. Cl. H04N 5/232; G03B 13/00

(52) U.S. Cl. 348/347

(57) ABSTRACT

A lens structure disposed in an image capturing device is provided, and is imaged by a lens group and an image capturing unit. When the user presses a zooming key of the image capturing device, a driving mechanism drives a zoom lens group having a plurality of lenses to rotate, so as to rotate one of the lenses to reach a position at the same optical axis as the lens group and the image capturing unit.

### CROSS-REFERENCE TO RELATED APPLICATIONS

This non-provisional application claims priority under 35 U.S.C. §119(a) on patent Application Ser. No(s). 095137780 filed in Taiwan, R.O.C. on Oct. 13, 2006, the entire contents of which are hereby incorporated by reference.

### BACKGROUND OF THE INVENTION

1. Field of Invention

The present invention relates to a lens structure, and more particularly, to a lens structure that selects a zoom lens through a rotating manner.

2. Related Art

Currently, as the vigorous development of science and technology, the digital products on the market are continuously developed to bring forth new products and have a low price. Consumer image capturing devices, such as cell phones, PDAs and digital still cameras (DSC) with image shooting function have been increasingly popularized. Especially, due to the convenient quick view function, the DSC has become a convenient tool for recording matters in people's daily life and work, which brings quite a lot of convenience.

For the commonly-used lens structure of the DSC, cylinder cam type lens (or called retractable lens) has been relatively widely applied. It has a plurality of optical lens groups disposed therein, and the positions of the optical lens groups are changed by protruding the lens forwards and retracting it backwards, so as to zoom in or enlarge the image to be captured, thereby adjusting to the best shooting focal length. The cylinder cam type lens has a certain retraction scope to make the DSC have excellent optical zooming function, such that it is easy to enlarge the target that is far away from here, without compromising too much definition.

The camera with the cylinder cam type lens has high magnification optical zooming function, but correspondingly, the operation travel required by the plurality of optical lens groups within the lens is too large, thus, it is impossible to reduce the volume of the lens. Therefore, the whole volume of the camera is excessively large, which is inconvenient for carrying along, and does not meet the requirements of being light and thin for electronic products. In addition, it is quite likely for the operator to carelessly drop down the camera during shooting, and if the cylinder cam type lens is protruded out at this time, it is easy to destroy the lens components.

In order to eliminate the limitation of the excessively large volume of the DSC with the cylinder cam type lens, the manufacturer develops a camera using a prism type lens for shooting. The lens group of the prism type lens is received within the body of the camera, the operating manner is not moving forwards and backwards as the cylinder cam type lens, but using a total reflection prism to refract the incident light for 90 degrees along a direction vertical to the optical axis, and then, the light is reflected into the optical lens group, and the optical lens group moves upwards and downwards to adjust the focal length.

The lens of the prism type lens is not required to be protruded out of the body of the camera, thus, the volume and thickness of the camera are greatly reduced, and the overall appearance of the camera is lighter and thinner, thereby enhancing the portability of the camera. However, since the operation travel and the aperture of the optical lens group of the prism type lens are relatively small, the optical zooming magnification and the effect are not as good as that of the cylinder cam type lens.

The conventional cylinder cam type lens and prism type lens respectively have the above features. If the features of the two lens components are combined together, the customer's requirements for the consumer image capturing device of being light and thin and having an excellent optical effect can be satisfied. However, the camera on the market must sacrifice one of the features (i.e., the excellent optical zooming function or the feature of being light and thin), so as to have the feature provided by the other kind of lens component.

### SUMMARY OF THE INVENTION

In view of the above problems, the present invention provides a lens structure, so as to eliminate the limitation of the conventional consumer image capturing device that it is impossible to have both the excellent optical zooming performance and the feature of the camera body of being light and thin.

The lens structure provided by the present invention is disposed in an image capturing device, and the captured image is displayed by an image capturing unit. The lens structure of the present invention comprises a housing having an accommodation space therein, a lens group, at least one zoom lens group, and at least one driving mechanism. The lens group is disposed within the accommodation space of the housing, and located at the same optical axis as the image capturing unit. The zoom lens group is disposed within the accommodation space, adjacent to the lens group and located on the same optical axis, and it has a plurality of lenses with different curvatures. The driving mechanism is disposed in the housing, and mutually connected to the zoom lens group. According to the shooting requirement of the user, the driving mechanism drives the zoom lens group to rotate, and makes one of the lenses rotate to reach a position at the same optical axis as the image capturing unit and the lens group.

The efficacy of the present invention lies in that, when the user presses the zooming key of the image capturing device according to the practical shooting condition, the driving mechanism drives the zoom lens group to rotate, so as to adjust the lens structure to the most suitable shooting focal length, without making the lens structure be protruded out of the body of the image capturing device. Thus, the objectives of the image capturing device, such as the light and thin volume and the excellent optical zooming function, can be achieved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic stereogram of the present invention applied to an image capturing device according to a first embodiment of the present invention;

FIG. 2 is an enlarged schematic stereogram of the first embodiment of the present invention;

FIG. 3 is a top perspective view of the present invention applied to an image capturing device according to the first embodiment of the present invention;

FIG. 4 is an enlarged schematic stereogram of a second embodiment of the present invention; and

FIG. 5 is a top perspective view of the present invention applied to an image capturing device according to the second embodiment of the present invention.

### DETAILED DESCRIPTION OF THE INVENTION

The lens structure provided by the present invention is applied in an image capturing device, and the image capturing device includes but is not limited to the consumer image capturing devices, such as DSCs, camera phones. In the following detailed description of the present invention, DSC is taken as the most preferred embodiment of the present invention. However, the attached drawings are only used for providing reference and illustration, but not to limit the present invention.

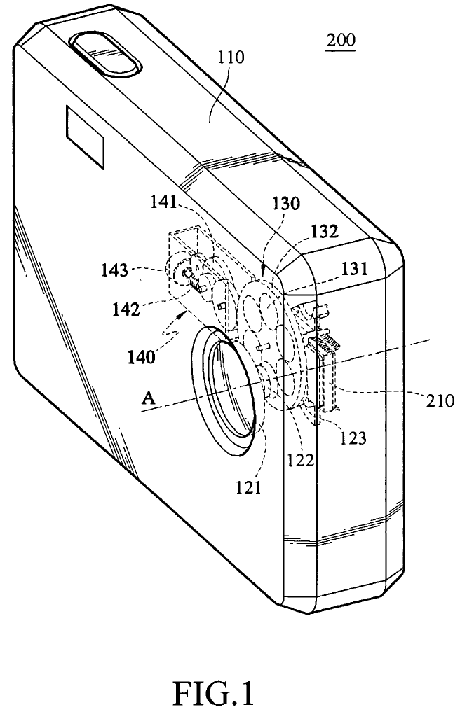

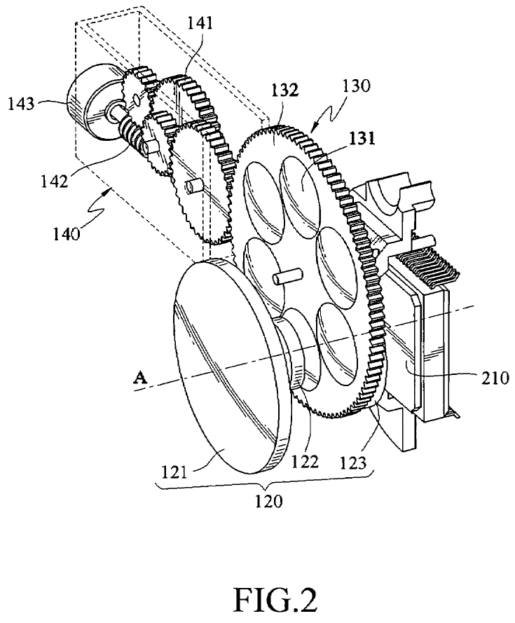

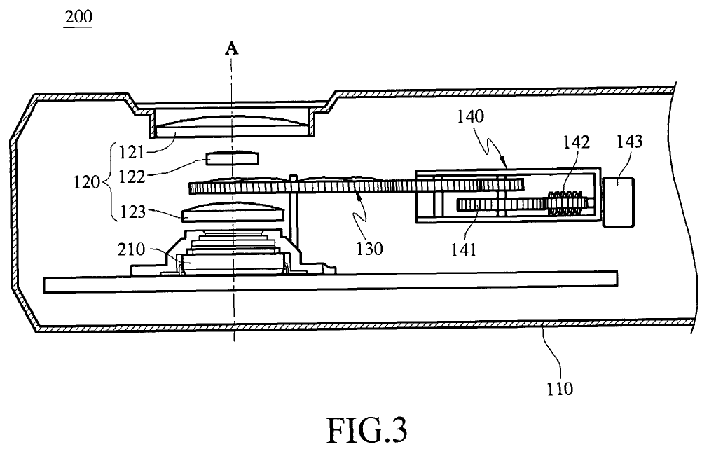

FIG. 1 to FIG. 3 are schematic stereogram and a top view of the first embodiment of the present invention. As shown in the figures, the lens structure provided by the present invention is disposed on an image capturing device 200, and displays the captured image by an image capturing unit 210. The lens structure of the present invention includes a housing 110, a lens group 120, a zoom lens group 130, and a driving mechanism 140. The housing 110 has an accommodation space therein, and the lens group 120 is disposed within the accommodation space, and located on the same optical axis A as the image capturing unit 210. The zoom lens group 130 is disposed adjacent to the lens group 120 and located on the optical axis A. The zoom lens group 130 has a plurality of lenses 131 with different curvatures. The driving mechanism 140 is disposed within the accommodation space of the housing 110, and mutually connected to the zoom lens group 130. When the user presses the zooming key (not shown) of the image capturing device 200, the driving mechanism 140 drives the zoom lens group 130 to rotate according to the signal from the zooming key, such that the zoom lens group 130 selectively rotates until one of the lenses 131 reaches a position at the same optical axis A as the image capturing unit 210 and the lens group 120.

As shown in FIG. 1 to FIG. 3, the lens group 120 provided by the present invention has a condensing lens 121, a refracting lens 122, and an automatic focusing lens 123. The condensing lens 121 is disposed on the housing 110 of the image capturing device 200, so as to condense the light close to the optical axis A. The refracting lens 122 is disposed between the condensing lens 121 and the zoom lens group 130, such that the light is refracted by the refracting lens 122 to pass through a zoom lens 131 located on the optical axis A, and pass through the automatic focusing lens 123 disposed on the other side of the zoom lens group 130 opposite to the refracting lens 122. Finally, the light enters the image capturing unit 210, so as to display the target image captured by the lens structure.

Referring to FIG. 1 to FIG. 3, the zoom lens group 130 has a disk 132, and the plurality of lenses 131 are uniformly and annularly arranged at positions adjacent to outer edge of the disk 132. A rotating pin is disposed at and passes through the center position of the disk 132, so as to make the zoom lens group 130 rotate at a fixing position in the accommodation space, and a saw-tooth structure is disposed at the outer edge of the disk 132, so as to mutually connect to the driving mechanism 140. The driving mechanism 140 used to drive the zoom lens group 130 to rotate has a gear set 141 connected to the disk 132, a worm gear 142 connected to the gear set 141, and a stepping motor 143 connected to the worm gear 142. According to the shooting requirement of the user, the stepping motor 143 drives the worm gear 142, and drives the gear set 141 connected to the outer edge of the disk 132, so as to make the zoom lens group 130 selectively rotate the zoom lens 131 with a suitable curvature to the optical axis A, thereby achieving the most preferred imaging quality.

In the present invention, the worm gear 142 is used to exactly drive the gear set 141, so as to adjust the rotating angle of the zoom lens group 130, and to solve the problem that the accumulated tolerance generated due to the excessive engaging of the gears causes dislocation when each lens 131 of the zoom lens group 130 rotates to the optical axis A, and thereby resulting in that the captured image cannot be correctly imaged.

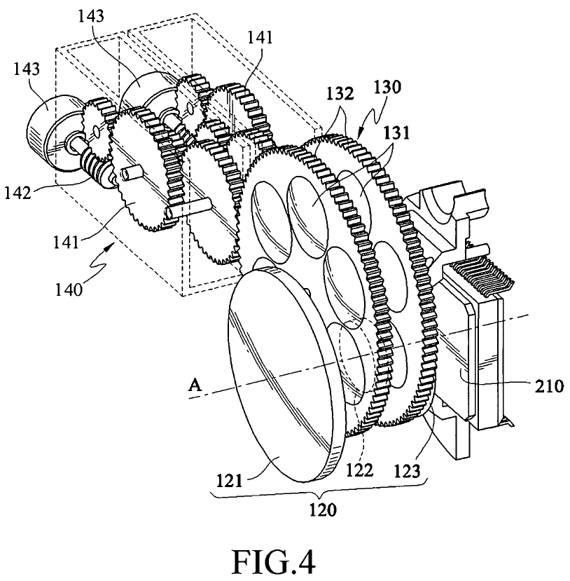

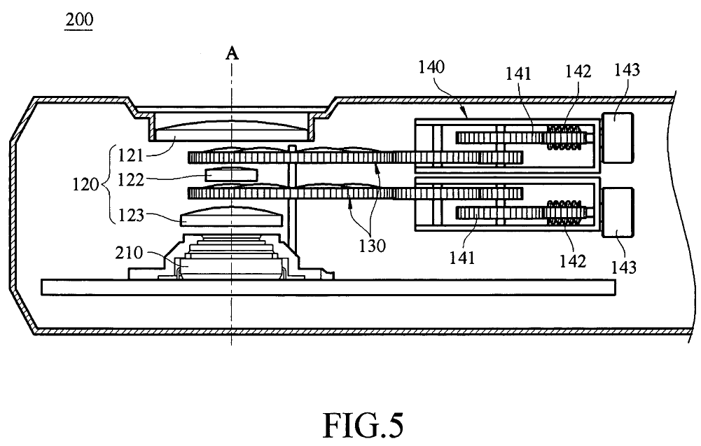

FIG. 4 and FIG. 5 are a schematic stereogram and a top view of the present invention applied to the image capturing device according to a second embodiment of the present invention. As shown in the figures, the lens structure of the second embodiment of the present invention includes a housing 110, a lens group 120, two corresponding zoom lens groups 130, and two driving mechanisms 140 respectively corresponding to the two zoom lens groups 130. The housing 110 has an accommodation space therein, and the lens group 120 is disposed within the accommodation space, and located on the same optical axis A as the image capturing unit 210. Two zoom lens groups 130 are disposed adjacent to the lens group 120, located on the optical axis A, and respectively have a plurality of lenses 131 with different curvatures. Two driving mechanisms 140 are disposed within the accommodation space of the housing 110, and respectively connected to the corresponding zoom lens groups 130. When the user presses the zooming key (not shown) of the image capturing device 200, two driving mechanisms 140 drive the zoom lens groups 130 to rotate according to the signal from the zooming key, such that the zoom lens groups 130 selectively rotates to make one of the lenses 131 reach a position at the same optical axis A as the image capturing unit 210 and the lens group 120. Two zoom lens groups 130 may match the zoom lenses 131 with different curvatures to provide different combinations of the focal length selections for the image capturing device 200.

As shown in FIG. 4 and FIG. 5, the lens group 120 provided by the present invention has a condensing lens 121, a refracting lens 122, and an automatic focusing lens 123. The condensing lens 121 is disposed on the housing 110 of the image capturing device 200, so as to condense the light close to the optical axis A. The refracting lens 122 is disposed between the two zoom lens groups 130, the light is refracted by the refracting lens 122 to pass through the lenses 131 of the two zoom lens groups 130 located on the optical axis A, and pass through the automatic focusing lens 123 disposed between the zoom lens groups 130 and the image capturing unit 210. Finally, the light enters the image capturing unit 210, so as to display the target image captured by the lens structure.

Referring to FIG. 4 and FIG. 5, the two zoom lens groups 130 respectively have a disk 132, and the plurality of lenses 131 are uniformly and annularly arranged at positions adjacent to the outer edge of the disk 132. A rotating pin is disposed at and passes through the center position of the two disks 132, so as to make the two zoom lens groups 130 rotate on a fixing position in the accommodation space. The two driving mechanisms 140 respectively have a gear set 141 connected to the disk 132 of the zoom lens group 130, a worm gear 142 connected to the gear set 141, and a stepping motor 143 connected to the worm gear 142. According to the shooting requirement of the user, the stepping motor 143 drives the worm gear 142, and drives the saw-tooth structure gear set 141 connected to the outer edge of the disk 132, such that the two zoom lens groups 130 selectively match with the most suitable zoom lenses 131 and rotate till reaching a position at the same optical axis A as the image capturing unit 210 and the lens group 120, thereby achieving the most preferred imaging quality.

In the lens structure provided by the present invention, a driving mechanism is used to drive the zoom lens group having a plurality of lenses with different curvatures to rotate, so as to enable the lens that meets the practical requirement to rotate to the position at the optical axis. Therefore, the image capturing device has the most preferred shooting focal length, and it meets the requirements for the image capturing device, such as the light and thin volume and the excellent optical zooming function, without extending out of the body as the conventional cylinder cam type lens structure, or sacrificing the optical zooming effect as the prism type lens.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A lens structure, disposed on an image capturing device, and displaying a captured image by an image capturing unit, comprising:
a housing, having an accommodation space;
a lens group, disposed within the housing, and located at the same optical axis as said image capturing unit;
at least one zoom lens group, disposed within the housing, adjacent to said lens group and located on said optical axis, and having a plurality of lenses with different curvatures; and
at least one driving mechanism, disposed within the housing, and connected to said zoom lens group, so as to drive said zoom lens group to rotate, wherein said zoom lens group selectively rotates till one of the lenses reaches a position at said optical axis.

2. The lens structure as claimed in claim 1, wherein said lens group has a condensing lens, a refracting lens, and an automatic focusing lens.

3. The lens structure as claimed in claim 1, wherein said zoom lens group has a disk, and the plurality of lenses is annularly arranged on the disk.

4. The lens structure as claimed in claim 1, wherein said driving mechanism has a gear set connected to said zoom lens group, a worm gear connected to the gear set, and a stepping motor connected to the worm gear, so as to drive said zoom lens group to rotate.
